(19) United States
(12) Patent Application Publication
(10) Pub. No.: US 2019/0043155 A1
(43) Pub. Date: Feb. 7, 2019

(54) SYSTEMS FOR PROCESSING IMAGE SIGNALS

(71) Applicant: SK hynix Inc., Icheon-si Gyeonggi-do (KR)

(72) Inventor: Hyung Seob BAE, Seoul (KR)

(73) Assignee: SK hynix Inc., Icheon-si Gyeonggi-do (KR)

(21) Appl. No.: 15/906,314

(22) Filed: Feb. 27, 2018

(30) Foreign Application Priority Data
Aug. 3, 2017 (KR) 10-2017-0098671

(51) Int. Cl. G06T 1/20; G09G 5/00; H04N 1/00; G06T 1/60

(52) U.S. Cl. CPC G06T 1/20; G09G 5/005; H04N 2201/0084; H04N 1/00129; G06T 1/60; G09G 5/006

(57) ABSTRACT

An image signal processing system includes a first processor and a memory. The memory is coupled to the first processor through a first memory interface and a second memory interface. The memory includes a first memory area and a second memory area. The first memory area stores image data outputted from the first processor through the first memory interface during an image processing operation of the first processor. The second memory area stores image data outputted from the first processor through the second memory interface.

### CROSS-REFERENCE TO RELATED APPLICATIONS

The present application claims priority under 35 U.S.C 119(a) to Korean Application No. 10-2017-0098671, filed on Aug. 3, 2017, which is incorporated by reference herein in its entirety.

### BACKGROUND

### 1. Technical Field

Various embodiments of the present disclosure relate to systems of processing image signals including image data outputted from digital imaging devices.

### 2. Related Art

Mobile systems such as mobile phones, portable media players (PMPs), and portable computers have been developed to include a digital imaging device, for example, a digital camera or a digital video recorder. The digital imaging device may be configured to include an image sensor. Data of images captured by the image sensor may be processed by an image processing pipe line. The image data processed by the image processing pipe line may be converted into visible images by a display device such as a monitor. As a resolution and a frame rate of the image data becomes higher, high performance image signal processing systems have been required.

### SUMMARY

According to an embodiment, an image signal processing system includes a first processor and a memory. The memory is coupled to the first processor through a first memory interface and a second memory interface. The memory includes a first memory area and a second memory area. The first memory area stores image data outputted from the first processor through the first memory interface during an image processing operation of the first processor. The second memory area stores image data outputted from the first processor through the second memory interface.

According to another embodiment, an image signal processing system includes a first processor and a memory coupled to the first processor through a memory interface. The memory includes a first memory area configured to store image data outputted from the first processor through the memory interface during an image processing operation of the first processor, a second memory area configured to store image data outputted from the first processor through the memory interface, and an internal bus coupled to the memory interface. The first memory area is coupled to the internal bus through a first internal memory interface, and the second memory area is coupled to the internal bus through a second internal memory interface.

### BRIEF DESCRIPTION OF THE DRAWINGS

Various embodiments of the present disclosure will become more apparent in view of the attached drawings and accompanying detailed description, in which:

FIG. 1 is a block diagram illustrating an image signal processing system according to an embodiment of the present disclosure;

FIG. 2 is a block diagram illustrating a memory included in the image signal processing system of FIG. 1;

FIG. 3 is a block diagram illustrating an image signal processing system according to another embodiment of the present disclosure; and

FIG. 4 is a block diagram illustrating a memory included in the image signal processing system of FIG. 3.

### DETAILED DESCRIPTION OF THE EMBODIMENTS

In the following description of the embodiments, it will be understood that the terms “first” and “second” are intended to identify an element, but not used to define the element itself or to mean a particular sequence. In addition, when an element is referred to as being located “on”, “over”, “above”, “under” or “beneath” another element, it is intended to mean a relative position relationship, but not used to limit certain cases that the element directly contacts the other element, or at least one intervening element is present therebetween. Accordingly, the terms such as “on”, “over”, “above”, “under”, “beneath”, “below” and the like that are used herein are for the purpose of describing particular embodiments only and are not intended to limit the scope of the present disclosure. Further, when an element is referred to as being “connected” or “coupled” to another element, the element may be electrically or mechanically connected or coupled to the other element directly, or may form a connection relationship or coupling relationship by replacing the other element therebetween.

Various embodiments are directed to image signal processing systems and methods of processing image signals.

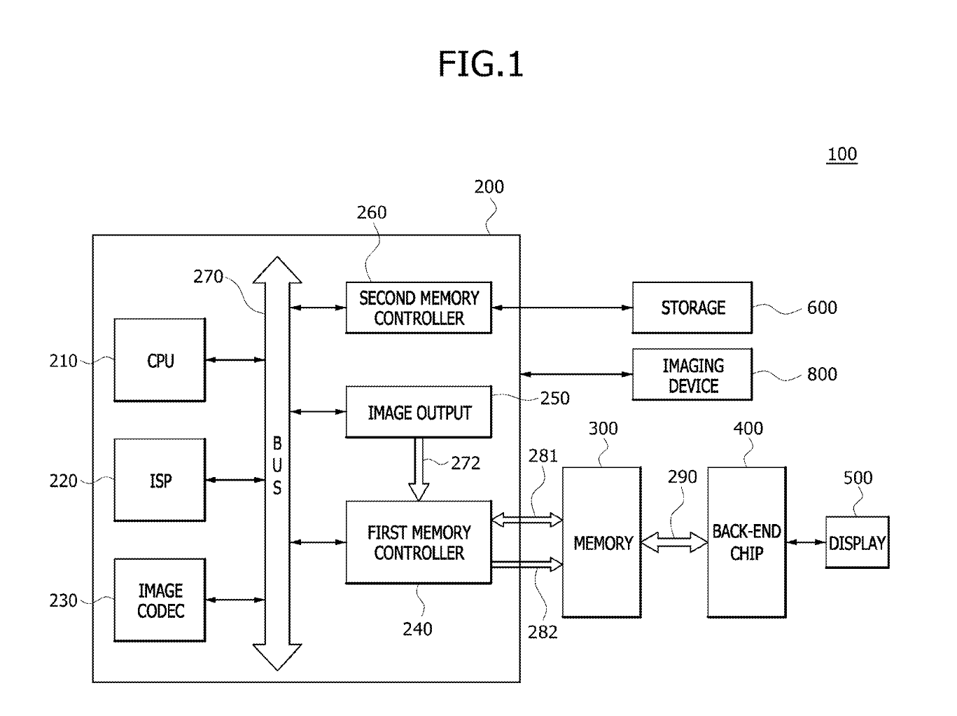

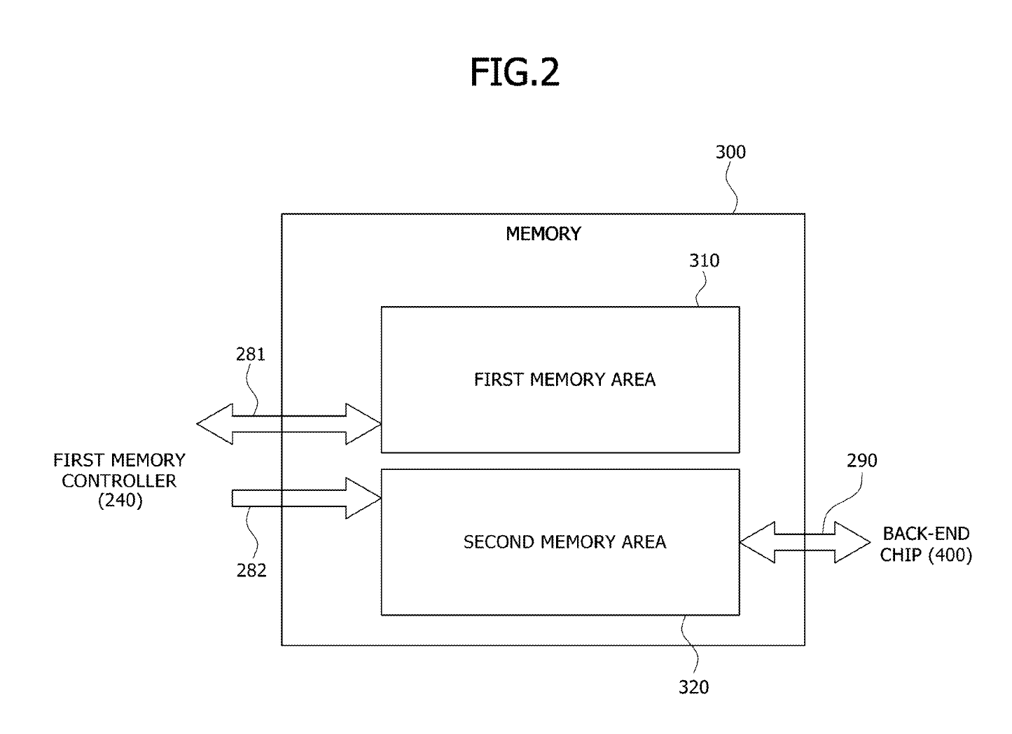

FIG. 1 is a block diagram illustrating an image signal processing system 100 according to an embodiment of the present disclosure, and FIG. 2 is a block diagram illustrating a memory 300 included in the image signal processing system 100 of FIG. 1. Referring to FIG. 1, the image signal processing system 100 may include a first processor 200 and a second processor 400. In an embodiment, the first processor 200 may be a camera scale processor (CSP). The CSP 200 may have a chip shape. The second processor 400 may correspond to a back-end chip. A memory 300 may be coupled between the CSP 200 and the back-end chip 400. The image signal processing system 100 may further include a display or display unit 500 and a storage or storage unit 600.

The CSP 200 may be configured to include a central processing unit (CPU) 210, an image signal processor (ISP) 220, an image codec 230, a first memory controller 240, an image output unit 250, and a second memory controller 260. The image output unit 250 may be implemented by circuits and/or a processor, and may be a monitor, a display, or any other type of mechanism that may be used for displaying an image. The CSP 200 may perform various processing operations on image data outputted from an external digital imaging device 800 such as a digital camera or a digital video recorder. The CPU 210, the ISP 220, the image codec 230, the first memory controller 240, the image output unit 250, and the second memory controller 260 included in the CSP 200 may be coupled with one another through a main bus 270 and sub-buses providing paths through which data is transmitted.

The CPU 210 may be a microprocessor including hardware components, software programs, and firmware programs which are necessary for processing the image data. The CPU 210 may be an advanced RISC machine (ARM) processor which is used in a system-on-chip (SOC). In an embodiment, the CPU 210 may include a graphic processing unit (GPU), which is also referred to as a video processing unit (VPU), to perform a series of complicated operations on the image data. The CPU 210 may perform operations for handling and rendering graphic images in relation to various electronic games and various application programs. The CPU 210 may control function of a camera or additional function of a multimedia player. For example, the CPU 210 may process the image data so that a size of images provided by the image data is consistent with a screen size of the display unit 500, and the CPU 210 may control various conversion operations of the image data so that colors of images displayed on the display unit 500 meet a color specification.

The ISP 220 may perform various operations (e.g., an operation for improving image quality or an operation for correcting images) on image data which is transmitted through the main bus 270. In an embodiment, the ISP 220 may include a Bayer processing unit, an RGB processing unit, or a size adjustment/rotation/affine transformation processing unit. In an embodiment, the ISP 220 may utilize composition vectors corresponding to an image size, a color temperature, and a color depth to control processes performed by elements constituting the CSP 200. The composition vectors may be written by the CPU 210 or the firmware programs and may be used to control various operations for adjusting a frame size of the data. For example, the composition vectors may control an image size, a color depth, a dead pixel correction, a lens shading compensation, an adaptive color interpolation, a color correction, a gamma control, a hue/gain control, an image effect, an auto exposure, an auto white balance, or the like.

The image codec 230 may encode or decode image data to provide encoded image data or decoded image data which are suitable for transmission or storage. In an embodiment, the image codec 230 may be realized using a joint photographic expert group (JPEG) codec. In such a case, the image codec 230 may apply a JPEG codec process to the image data outputted from the external digital imaging device 800 to generate JPEG image data having a small capacity and a high resolution.

The first memory controller 240 may be coupled to the memory 300 through a first memory interface 281 corresponding to a bidirectional interface and a second memory interface 282 corresponding to a unidirectional interface. Specifically, the first memory controller 240 may be coupled to the first and second memory interfaces 281 and 282 to control an operation of the memory 300. For example, the first memory controller 240 may transmit image data processed by the various elements included in the CSP 200 to the memory 300. In such a case, the image data outputted from the first memory controller 240 may be transmitted to the memory 300 through the first memory interface 281 or the second memory interface 282. In one example, a first memory area 310 may store image data outputted from the CSP 200 through the first memory interface 281 during an image processing operation of the CSP 200. The first memory controller 240 may read out data stored in the memory 300 and may transmit the data stored in the memory 300 to various elements included in the CSP 200. In this case, data stored in the memory 300 may be transmitted to various elements included in the CSP 200 through only the first memory interface 281. The first memory controller 240 may communicate with various elements included in the CSP 200 through the main bus 270 and any one of the sub-buses. The first memory controller 240 may directly receive image data from the image output unit 250 without using the main bus 270 to improve an output speed of the image data. In such a case, the image data outputted from the image output unit 250 may be transmitted to the first memory controller 240 through an image output bus 272, where the image output unit 250 may be coupled to the first memory controller 240 through the image output bus 272.

The image output unit 250 may output image data generated by the external digital imaging device 800 and/or the image data processed by the CSP 200 to an element disposed in a region outside the CSP 200. If the image output unit 250 outputs the image data provided by the external digital imaging device 800, the image data provided by the external digital imaging device 800 is not processed by the CSP 200 but transmitted to the back-end chip 400 and an image preview device. If the image output unit 250 outputs image data processed by the CSP 200, the image output unit 250 may process the image data captured by the image codec 230 so that the image data may have a frame rate adjusted by a user and may output the image data having the adjusted frame rate.

The second memory controller 260 may control data transmission between the CSP 200 and the storage unit 600. In an embodiment, the storage unit 600 may include a nonvolatile memory device. The storage unit 600 may be configured to include a universal serial bus (USB) drive, a hard disk drive (HDD), or a solid state drive (SSD).

The memory 300 may store the image data to be processed by the CSP 200 or may store the image data processed by the CSP 200. In an embodiment, the memory 300 may be a volatile memory device such as a synchronous dynamic random access memory (SDRAM). As illustrated in FIG. 2, the memory 300 may include the first memory area 310 and a second memory area 320. The first and second memory areas 310 and 320 may be distinguished from each other by an address. The first memory area 310 may be coupled to the first memory controller 240 through the first memory interface 281. Because the first memory interface 281 is a bidirectional interface, the first memory controller 240 may perform both of a read operation and a write operation on the first memory area 310. Thus, the first memory area 310 may be used as a buffer memory or a cache memory while the image data is processed by the CSP 200.

The second memory area 320 may be coupled to the first memory controller 240 through the second memory interface 282. Because the second memory interface 282 is a unidirectional interface through which image data is transmitted in only in a single direction from the first memory controller 240 toward the second memory area 320, the first memory controller 240 may only perform a write operation on the second memory area 320. Thus, the second memory area 320 may merely be used as a memory region for storing image data outputted from the image output unit 250 of the CSP 200.

The second memory area 320 may be coupled to the back-end chip 400 through a bidirectional data interface 290. Thus, image data stored in the second memory area 320 may be transmitted to the back-end chip 400. In addition, image data outputted from the back-end chip 400 may be stored in the second memory area 320. That is, the back-end chip 400 may perform both a read operation and a write operation on the second memory area 320.

Referring again to FIG. 1, the back-end chip 400 may process image data which is displayed on the display unit 500. The display unit 500 may be coupled to a camera, a computer, or the like. In an embodiment, the back-end chip 400 may include a multimedia processor (MMP) or an application processor (AP). The back-end chip 400 may receive image data stored in the second memory area 320 of the memory 300 and may transmit image data to the display unit 500 in an appropriate operation mode. In an embodiment, the operation mode may include a preview mode and a multimedia mode. In the event that the display unit 500 is coupled to a camera, the preview mode may be an operation mode for displaying images before taking pictures with the camera, and the multimedia mode may be an operation mode for taking pictures with the camera.

In general, it may be necessary to dispose a high performance serial interface transmitting image data at a high speed with high resolution between the image output unit 250 and the back-end chip 400 to transmit image data from the image output unit 250 to the back-end chip 400. For example, it may be necessary to dispose a mobile industry processor interface (MIPI) between the image output unit 250 and the back-end chip 400 to transmit image data from the image output unit 250 to the back-end chip 400. That is, if the resolution and the frame rate of the image data become higher, it may be necessary to replace an interface between the image output unit 250 and the back-end chip 400 with a high performance serial interface having a platform suitable for high resolution and a high frame rate of the image data. However, in the case of the image signal processing system 100, the first memory controller 240 and the memory 300 may be disposed between the image output unit 250 and the back-end chip 400. Thus, no high performance serial interface may be additionally required.

Specifically, image data outputted from the image output unit 250 may be transmitted and stored in the second memory area 320 of the memory 300 through the first memory controller 240 and the second memory interface 282. The back-end chip 400 may then access the image data stored in the second memory area 320 of the memory 300. If the memory 300 is an SDRAM, an SDRAM interface may be used as the second memory interface 282. It is well known in the art that the SDRAM interface exhibits a relatively high data transmission speed as compared with a general serial interface. Thus, image data having a high resolution with a high frame rate may be transmitted from the image output unit 250 to the second memory area 320. Moreover, even though it is required to transmit image data having a higher resolution with a higher frame rate, the image signal processing system 100 may successfully transmit the image data from the image output unit 250 to the second memory area 320 by reconstructing the SDRAM interface to increase a data transmission speed of the SDRAM interface without changing a platform of the CSP 200.

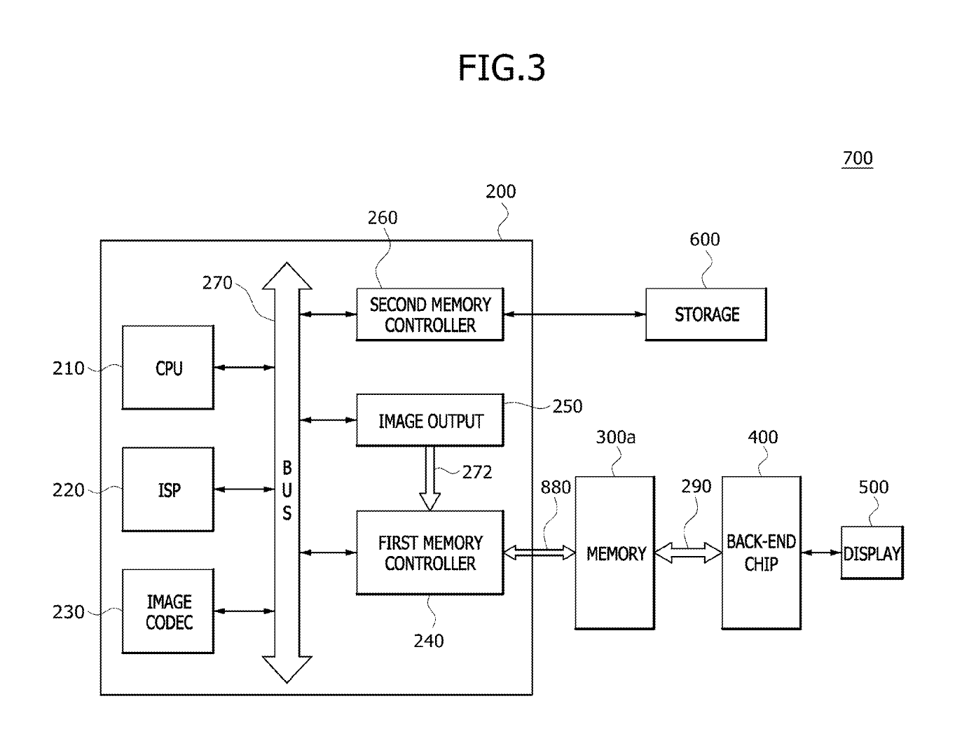

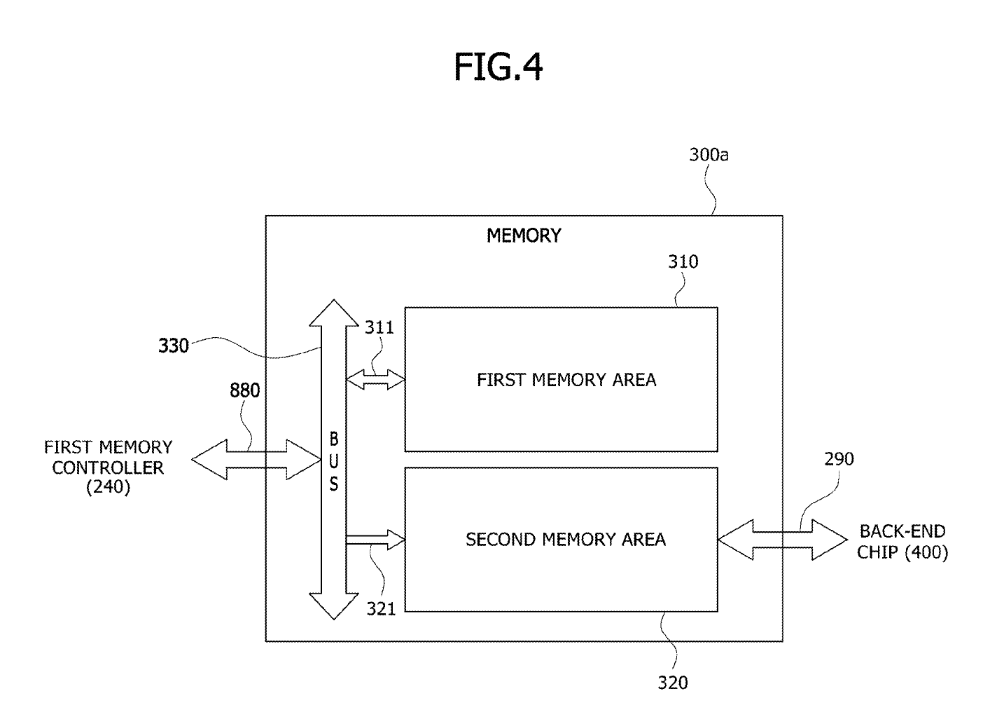

FIG. 3 is a block diagram illustrating an image signal processing system 700 according to another embodiment of the present disclosure, and FIG. 4 is a block diagram illustrating a memory 300a included in the image signal processing system 700 of FIG. 3. In FIGS. 3 and 4, the same reference numerals as used in FIGS. 1 and 2 denote the same elements. Thus, the descriptions of the same elements as set forth with reference to FIGS. 1 and 2 will be omitted or briefly mentioned hereinafter to avoid duplicate explanation. Referring to FIG. 3, the first memory controller 240 may be coupled to the memory 300a through a bidirectional memory interface 880. The CSP 200 may include the first memory controller 240 that may be coupled to the memory interface 880 to control an operation of the memory 300a. The first memory controller 240 may transmit image data processed by various elements of the CSP 200 to the memory 300a through the memory interface 880. In addition, the first memory controller 240 may read out data stored in the memory 300a through the memory interface 880, and the first memory controller 240 may transmit the data stored in the memory 300a to the various elements included in the CSP 200.

As illustrated in FIG. 4, the memory 300a may include the first memory area 310 and the second memory area 320. The first and second memory areas 310 and 320 may be distinguished from each other by an address. The memory 300a may further include an internal bus 330. The internal bus 330 may be coupled to the memory interface 880. The internal bus 330 may also be coupled to a first internal memory interface 311 corresponding to a bidirectional interface and a second internal memory interface 321 corresponding to a unidirectional interface. The first internal memory interface 311 may connect the internal bus 330 to the first memory area 310 of the memory 300. The second internal memory interface 321 may connect the internal bus 330 to the second memory area 320 of the memory 300.

The first memory area 310 may be coupled to the first memory controller 240 through the first internal memory interface 311, the internal bus 330, and the memory interface 880. Because both the first internal memory interface 311 and the memory interface 880 are bidirectional interfaces, the first memory controller 240 may perform both of a read operation and a write operation on the first memory area 310. Thus, the first memory area 310 may be used as a buffer memory or a cache memory while image data is processed by the CSP 200. The second memory area 320 may be coupled to the first memory controller 240 through the second internal memory interface 321, the internal bus 330, and the memory interface 880. Because the second internal memory interface 321 is a unidirectional interface transmitting image data from the internal bus 330 to the second memory area 320 while the memory interface 880 is a bidirectional interface, the first memory controller 240 may only perform a write operation on the second memory area 320. Thus, the second memory area 320 may be merely used as a memory region for storing image data outputted from the image output unit 250 of the CSP 200.

The second memory area 320 may be coupled to the back-end chip 400 through the bidirectional data interface 290. Thus, image data stored in the second memory area 320 may be transmitted to the back-end chip 400. In addition, image data outputted from the back-end chip 400 may be stored in the second memory area 320. That is, the back-end chip 400 may perform both a read operation and a write operation on the second memory area 320.

The embodiments of the present disclosure have been disclosed above for illustrative purposes. Those of ordinary skill in the art will appreciate that various modifications, additions, and substitutions are possible, without departing from the scope and spirit of the present disclosure as disclosed in the accompanying claims.

What is claimed is:

1. An image signal processing system comprising:
a first processor; and
a memory coupled to the first processor through a first memory interface and a second memory interface,
wherein the memory comprises:
a first memory area configured to store image data outputted from the first processor through the first memory interface during an image processing operation of the first processor; and
a second memory area configured to store image data outputted from the first processor through the second memory interface.

2. The image signal processing system of claim 1, wherein the first processor processes image data outputted from an external digital imaging device.

3. The image signal processing system of claim 1, wherein the first processor includes a first memory controller that is coupled to the first and second memory interfaces to control an operation of the memory.

4. The image signal processing system of claim 3,
wherein the first processor further includes an image output unit that outputs image data generated by an external digital imaging device; and
wherein the image output unit is coupled to the first memory controller through an image output bus.

5. The image signal processing system of claim 3, further comprising a storage unit,
wherein the first processor further includes a second memory controller that controls data transmission between the first processor and the storage unit.

6. The image signal processing system of claim 1,
wherein the first memory interface is a bidirectional interface; and
wherein the second memory interface is a unidirectional interface through which image data are transmitted only in a single direction from the first processor toward the memory.

7. The image signal processing system of claim 6,
wherein the first processor performs a read operation and a write operation on the first memory area; and
wherein the first processor performs only a write operation on the second memory area.

8. The image signal processing system of claim 1, further comprising a second processor which is coupled to the memory through a data interface.

9. The image signal processing system of claim 8, wherein the data interface is coupled to the second memory area of the memory.

10. The image signal processing system of claim 9, wherein the data interface is a bidirectional interface.

11. The image signal processing system of claim 9,
wherein the first processor performs a read operation and a write operation on the first memory area;
wherein the first processor performs only a write operation on the second memory area; and
wherein the second processor performs a read operation and a write operation on the second memory area.

12. An image signal processing system comprising:
a first processor; and
a memory coupled to the first processor through a memory interface,
wherein the memory comprises:
a first memory area configured to store image data outputted from the first processor through the memory interface during an image processing operation of the first processor;
a second memory area configured to store image data outputted from the first processor through the memory interface; and
an internal bus coupled to the memory interface,
wherein the first memory area is coupled to the internal bus through a first internal memory interface, and the second memory area is coupled to the internal bus through a second internal memory interface.

13. The image signal processing system of claim 12, wherein the first processor processes image data outputted from an external digital imaging device.

14. The image signal processing system of claim 12, wherein the first processor includes a first memory controller that is coupled to the memory interface to control an operation of the memory.

15. The image signal processing system of claim 14,
wherein the first processor further includes an image output unit that outputs image data generated by an external digital imaging device; and
wherein the image output unit is coupled to the first memory controller through an image output bus.

16. The image signal processing system of claim 14, further comprising a storage unit,
wherein the first processor further includes a second memory controller that controls data transmission between the first processor and the storage unit.

17. The image signal processing system of claim 12,
wherein the first processor performs a read operation and a write operation on the first memory area; and
wherein the first processor only performs a write operation on the second memory area.

18. The image signal processing system of claim 12, further comprising a second processor which is coupled to the memory through a data interface.

19. The image signal processing system of claim 18, wherein the data interface is coupled to the second memory area of the memory.

20. The image signal processing system of claim 19, wherein the data interface is a bidirectional interface.

21. The image signal processing system of claim 19,
wherein the first processor performs a read operation and a write operation on the first memory area;
wherein the first processor performs only a write operation on the second memory area; and
wherein the second processor performs a read operation and a write operation on the second memory area.
